(19) United States
(12) Patent Application Publication
(10) Pub. No.: US 2003/0203082 A1
(43) Pub. Date: Oct. 30, 2003

(54) Inhibition of non-enzymatic browning

(75) Inventors: Andrew Daniher, Cincinnati, OH (US); Stefan Furrer, Cincinnati, OH (US)

Correspondence Address: WOOD, HERRON & EVANS, LLP, 2700 CAREW TOWER, 441 VINE STREET, CINCINNATI, OH, 45202, US

(73) Assignee: Givaudan SA, Vernier (CH)

(21) Appl. No.: 10/134,433

(22) Filed: Apr. 30, 2002

(51) Int. Cl. A23G 1/00

(52) U.S. Cl. 426/133

(57) ABSTRACT

A method and device to inhibit non-enzymatic browning in susceptible foodstuffs, such as fruit products. An inhibitor of non-enzymatic browning is contained within a container for the foodstuff to contact the foodstuff and hence reduce, retard, or prevent browning. The inhibitor may be integral to the container or added to the container. The inhibitor may be contained within or on a support structure that is integral with, or added to, a food-contacting internal surface of the container. The foodstuff thus contained will desirably have reduced off-color, off-notes, and/or off-tastes that may be imparted by compounds associated with non-enzymatic browning.

### FIELD OF THE INVENTION

This invention relates to a method and device to decrease non-enzymatic browning of foodstuffs.

### BACKGROUND OF THE INVENTION

Some foodstuffs, such as fruits and fruit juices, undergo browning upon exposure to air. Browning occurs by both enzymatic and non-enzymatic reactions. In non-enzymatic browning, one or more amino containing compounds, such as amino acids, and carbonyl containing compounds, such as reducing sugars, that are present in the foodstuff react to produce products which impart an undesirable brown color to the food. This reaction, termed the Malliard reaction, involves a series of complex consecutive and interconnected processes which involve the formation of glucosamines, ketosamines via Amadori rearrangements, diketosamines, and degradations and polymerizations of these compounds. Because heating may accelerate the Malliard reaction, foodstuffs that undergo processing steps which involve heat may be particularly susceptible to non-enzymatic browning.

Besides imparting a brown color to foodstuffs, non-enzymatic browning is undesirable for other reasons. Non-enzymatic browning forms new aroma and/or flavor compounds, referred to as off-notes and off-tastes, respectively, which may not be favorable to the quality of the product. The new compounds may also shorten the shelf life of the foodstuff, leading to distribution, marketing, and economic concerns. Malliard reaction products deplete the existing nutritional pool of molecules, such as amino acids, in the foodstuff, leading to nutritional concerns. In addition, some Malliard reaction products may be mutagenic, leading to safety concerns. Hence, there is great interest in inhibiting, retarding, or reducing non-enzymatic browning in foodstuffs.

Several approaches, involving physical and chemical mechanisms, have been used toward this end. One approach, as disclosed in U.S. Pat. No. 5,888,568, adds a hydrocolloid gel to dairy products or sauces. The gel limits non-enzymatic browning by physically preventing the reactive glucosamines and ketosamines from interacting with each other. Another approach adds sulfur-containing compounds to foods. Sulfur limits non-enzymatic browning by its action as a reducing agent, a scavenger of free radicals, or a nucleophile that reacts with and traps electrophiles and other intermediates in the Malliard reaction. For example, the sulfur-containing amino acid cysteine has been added to pears, and sulfur dioxide and cysteine, as well as other thiols such as glutathione and N-acetyl-L-cysteine, have been added to citrus products to inhibit non-enzymatic browning.

The use of additives, however, may initiate other concerns. They may have the undesirable effect of introducing unwanted flavors to the foodstuff. Their use may also be restricted or regulated; for example, additives to citrus products cannot be artificial and must be from the named fruit (FTNF) according to state and federal regulations. Furthermore, foodstuffs come in a variety of formulations and containers, and an additive for one type of formulation or container may not be amenable or effective with the same foodstuff in a different formulation or container.

Certain foodstuffs themselves, or their methods of processing or packaging, cause particular concerns regarding non-enzymatic browning. As previously described, it is known that heat accelerates non-enzymatic browning, yet many foodstuffs are subjected to processing steps involving heat (e.g., pasteurization, concentration, evaporation, etc.). It is also known that ultraviolet light accelerates non-enzymatic browning, yet many foodstuffs are packaged in glass containers for aesthetic or other reasons and hence are exposed to ultraviolet light.

Therefore, additional methods and devices which limit non-enzymatic browning in foodstuffs are needed.

### SUMMARY OF THE INVENTION

The invention provides an inhibitor compound contained in a container for a foodstuff that has the capacity to desirably inhibit, prevent, reduce, arrest, or forestall non-enzymatic reactions in reactants which impart a brown color to a foodstuff contained in the container. Hereinafter the term “inhibitor compound” is used to refer to a compound that effects non-enzymatic browning in any of the above-listed ways, although the effect may be other than inhibitory, and instead may be to prevent, reduce, arrest, or forestall non-enzymatic browning reactions. Thus, the terms “inhibitor compound” and “inhibit” are used broadly.

The inhibitor compound may be either an integral part of the container, or may be a separate structure capable of being contained within the container. For example, the inhibitor compound may be adapted via a supporting structure to an inner surface of a container, or may be carried freely in the container by a supporting structure. The supporting structure may be any shape, such as a sphere, a bead, a sheet, a cylinder, etc. The supporting structure may be inert and may comprise a portion of the container itself. The inhibitor compound within the container contacts the foodstuff sufficiently to inhibit non-enzymatic browning of the contained foodstuff.

The invention is also directed to a method to inhibit non-enzymatic browning in a foodstuff contained within a container. In the method, the contained foodstuff is contacted with the inhibitor compound located in a food-contacting portion of the container under conditions sufficient to inhibit non-enzymatic browning. The container may contain a citrus product, such as a juice.

The invention is also directed to a support structure that accommodates an inhibitor compound of non-enzymatic browning. The support structure may be inserted in a container either before, during, or after addition of the foodstuff to the container. These and other aspects of the invention will be further appreciated in view of the following drawings, detailed description, and examples.

### BRIEF DESCRIPTION OF THE DRAWINGS

FIG. 1A schematically illustrates an inhibitor compound adapted to a matrix of a container.

FIG. 1B schematically illustrates an inhibitor compound directly adapted to an interior surface of a container.

FIG. 1C schematically illustrates an inhibitor compound indirectly adapted to an interior surface of a container.

FIG. 1D schematically illustrates an inhibitor compound contained by a porous structure and indirectly adapted to an interior surface of a container.

FIG. 2 schematically illustrates an inhibitor compound directly and indirectly adapted to a freely movable support structure.

FIG. 2A schematically illustrates an inhibitor compound directly and indirectly adapted to a surface of a freely movable spherical support structure.

FIG. 2B schematically illustrates an inhibitor compound directly and indirectly adapted to a surface of a flat support structure.

FIG. 2C schematically illustrates an inhibitor compound directly and indirectly adapted to a surface of a cylindrical support structure.

FIG. 3 schematically illustrates adaptation of the inhibitor compound 1,3-propane dithiol to a styrene bead support structure via a linker.

FIG. 4 is a graph depicting the extent of non-enzymatic browning in orange juice in the presence and absence of an inhibitor compound attached to a support structure within the juice container.

FIG. 5 is a histogram showing the effect of reagents on the browning of orange juice.

### DETAILED DESCRIPTION OF THE INVENTION

The invention is directed to one or more inhibitor compounds contained in a container for a foodstuff in concentrations or amounts effective to inhibit non-enzymatic browning reactions in the contained foodstuffs. Non-enzymatic browning reactions impart an undesirable color, taste, and/or odor, or a perception of an undesirable color, taste, and/or odor, to a foodstuff such as a citrus juice.

As used herein, the term foodstuff broadly includes all products that are ingested. These encompass foods and beverages in all forms, including forms requiring reconstitution, and whether they provide nutritive value or not. Hence, besides foods and beverages, foodstuffs include condiments, sauces, dressings, confections, nutraceuticals, gelatins, pharmaceutical and non-pharmaceutical gums, tablets, lozenges, drops, emulsions, elixirs, syrups, etc.

As used herein, the term container broadly includes any type of package or holder in which a foodstuff is contained. It is not limited by composition, size, form, or the type of foodstuff contained. As one example, a container may be a product to contain a solid, semi-solid, gel, or liquid, such as a paper or plastic carton for refrigerated juice, or a paper, plastic, or metal cylinder for a concentrated juice or juice drink. As another example, a container may be a plastic jug to contain a liquid. As still other examples, a container may be a metal can, a foil or paper pouch, a glass or plastic bottle, a foam package, etc., to contain a foodstuff such as non-refrigerated juice. The above examples are illustrative only, since other types of containers are contemplated, and the invention is not limited by the type, form, size, or composition of the container or the foodstuff contained therein.

In one embodiment, the inhibitor compound is irreversibly contained on a support structure to prevent the inhibitor compound from migrating freely into the bulk foodstuff. The support structure is inert and non-reactive with the foodstuff contained or to be contained. As used herein, the term “inhibit” broadly includes reactions which inhibit, prevent, reduce, retard, arrest, or forestall non-enzymatic browning reactions, and the terms “inhibitor” or “inhibitor compound” broadly includes compounds that perform the aforesaid actions.

In another embodiment, the inhibitor compound may be irreversibly adapted to a support structure within the container. An example of a support structure may be an inner surface of the container that contacts the foodstuff, whether the contact is intermittent or constant. In this regard, the inhibitor may be an integral part of the container, such as in an inner wall of the container as one of the components that comprise the wall matrix, or in a coating on the wall. Alternatively, the inhibitor may be irreversibly attached to a support structure. The support structure may be either directly or indirectly attached to an inner surface of the container, or may be carried freely in the container.

The inhibitor compound is configured so that a contained foodstuff contacts the inhibitor during manufacture, storage, transient, and/or use sufficient to inhibit non-enzymatic browning of the foodstuff. The container to which the inhibitor compound is added may already contain the foodstuff, or may be capable of containing the foodstuff. The entire volume or amount of the foodstuff need not be in contact with the inhibitor compound at all times. As one example, the inhibitor compound may be exposed to the foodstuff continuously or intermittently (e.g., during agitation of the container as occurs during transport, removal of a foodstuff from the container, or as directed to mix the contents and/or to accelerate the activity if the inhibitor compound). As another example, the inhibitor compound attached to a support structure is added to a container already containing the foodstuff upon opening the container after a period of storage. The use of a support structure permits the inhibitor compound to be easily located and removed from the container, if desired. Thus, it will be appreciated by one skilled in the art that the contact between the inhibitor compound and the foodstuff may be partial or complete, and may be for any period of time which is sufficient to inhibit non-enzymatic browning. Inhibition of non-enzymatic browning may be determined by methods including, but not limited to, visual inspection, spectrophotometric quantitation, taste, smell, etc. of the foodstuff. Thus, the invention encompasses any type or duration of exposure of the contained foodstuff to the inhibitor compound sufficient to inhibit non-enzymatic browning.

With regard to the inhibitor, any type of physiologically acceptable non-enzymatic browning inhibitor, either alone, in combination with other inhibitors, or in combination with other compounds, may be used. Various types of the aforementioned inhibitors are known to one skilled in the art. As one example, the inhibitor may be a thiol (—SH)-containing compound such as 1,3-propane dithiol, propane dithiol resin, ethyl 3-mercapto propanoate, cysteine, N-acetyl-L-cysteine, cysteine hydrochloride, ethyl acrylate, or polyphenolic compounds such as the flavonoids which are free radical scavengers. The inhibitor compound is covalently attached either directly or indirectly to a solid support structure, permitting it to interact with but be separable from the foodstuff. The inhibitor compound is present on the solid support at a concentration up to about 1.7 mmol/g. In one embodiment, the inhibitor compound is present on the solid support at a concentration up to about 0.45 mmol/g. As known to one skilled in the art, different concentrations of the inhibitor compound may be used depending upon the particular solid support, inhibitor compound, and systhesis reaction.

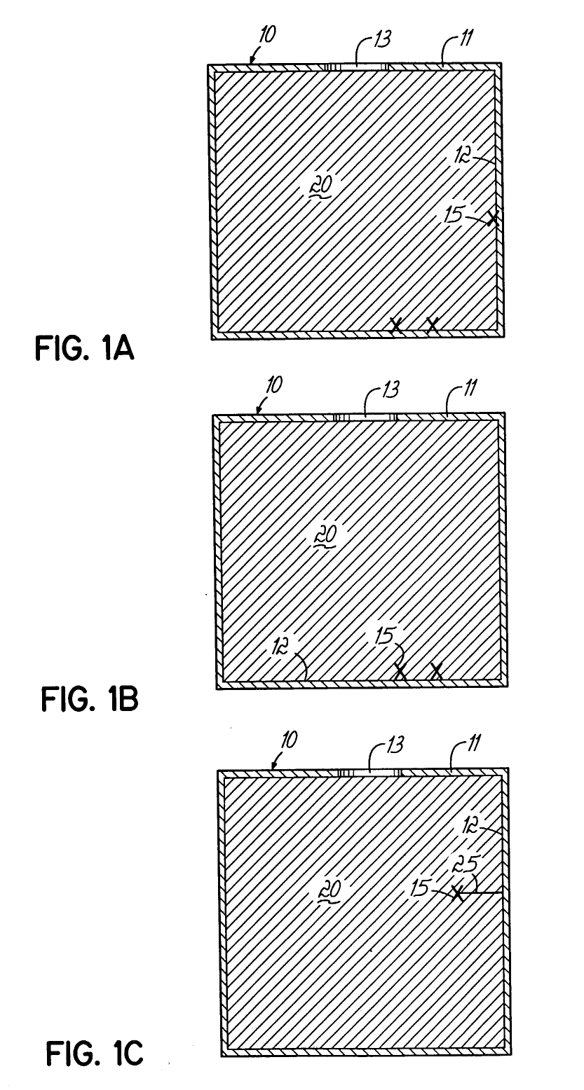

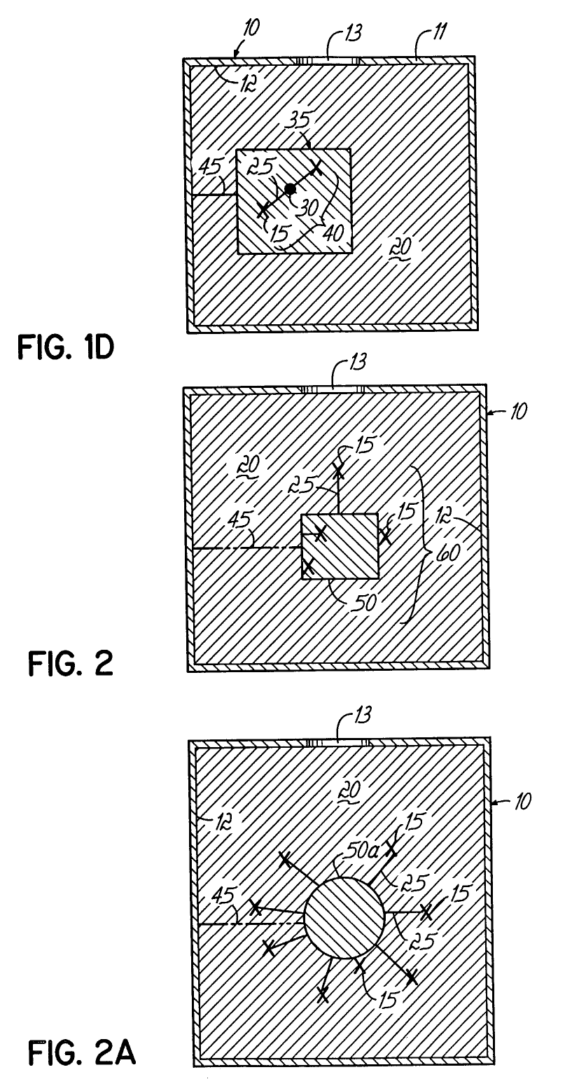

In embodiments illustrated as FIGS. 1A-D, a container 10 contains at least one non-enzymatic browning inhibitor compound 15. The inhibitor compound 15 may be part of the matrix 11 of the container 10 or may be irreversibly adapted to a support structure such as the container 10 itself. The inhibitor compound 15 is configured to contact the foodstuff 20 that will be contained or is contained in the container 10. The irreversible adaptations are achieved through processes, such as covalent reactions, that are known to one skilled in the art.

In the embodiment illustrated at FIG. 1A, the inhibitor compound 15 is directly adapted to the container 10. In this embodiment, the inhibitor compound 15 is configured in the polymers of the matrix 11 of the container 10 such that it is part of a surface of the inner wall 12 of the container 10. Thus the inhibitor 15 is in at least partial contact with the bulk foodstuff 20. The inhibitor compound 15 is irreversibly adapted to one or more components that form the container matrix 11. For example, the inhibitor compound 15 may be incorporated as part of the polymer synthesis or may be functionalized to the polymerized component(s).

In the embodiment illustrated at FIG. 1B, the inhibitor compound 15 is irreversibly and directly adapted to a surface of the inner wall 12 of the container 10, such as by coating the inner wall 12 of the container 10 and covalently binding the inhibitor compound 15 to the coating.

In the embodiment illustrated at FIG. 1C, an inhibitor compound 15 is indirectly adapted to an interior surface wall 12 of the container 10. In this embodiment, an inhibitor compound 15 is irreversibly adapted via a linker 25, which in turn is irreversibly adapted to an inner wall 12 of a container 10. The irreversible adaptation may be by covalent bonding. A plurality of the inhibitor 15/linker 25 units may be adapted to an inner wall 12 of a container 10. The linker is of a length that allows the inhibitor compound 15 to move freely within the foodstuff 20 but not allowing the inhibitor 15 to be freely soluble in the foodstuff 20. This embodiment permits the inhibitor compound 15 to extend further into the container 10 from the surface of the inner wall 12, which provides increased surface area for access of the foodstuff to the inhibitor compound 15, while allowing the inhibitor compound 15 to remain associated with the inner wall 12 of container 10. The linker 25 may be covalently bonded to the inner wall 12 of the container 10. The linker 25 may be inert so that it does not react with the foodstuff 20. Alternatively, the linker 25 may be hydrophilic so that it may be used with aqueous-based foodstuffs 20 such as juices. This would permit the inhibitor compound 15 to be soluble in solution but easily removed due to its attachment to support structure 50. In one embodiment, the linker is propyleneglycol.

In the embodiment illustrated at FIG. 1D, the inhibitor compound 15 is irreversibly adapted to a linker 25 that is itself adapted to a support structure, such as a sphere 30. A plurality of the units containing the inhibitor 15, linker 25, and sphere 30, referred to as an inhibitor/support unit 40, is contained by a three-dimensional containment structure or subcontainer 35 which allows access of the inhibitor compound 15 to the foodstuff 20. Thus, the subcontainer 35 may be at least partially porous and/or permeably sufficient to permit the foodstuff 20 to interact with the inhibitor compound 15 inside the sphere 30. The subcontainer 35 may take any shape or form, such as a bag, pouch, sac, cube, rectangle, sphere etc., and may be of any composition or material that is able to withstand contact with the inhibitor compound 15 and foodstuff 20 without substantial disintegration or degradation, such as a filter paper or membrane. Subcontainer 35 prevents the inhibitor/support unit 40 from freely migrating into the bulk foodstuff 20. The subcontainer 35 may be irreversibly adapted to an extended linker 45, which is irreversibly attached to an inner wall 12 of the container 10 and is inert so that it does not react with the foodstuff 20. A plurality of the subcontainers 35 may be adapted to the surface of one or more inner walls 12 of container 10. The subcontainer 35 may also be freely movable in the foodstuff 20.

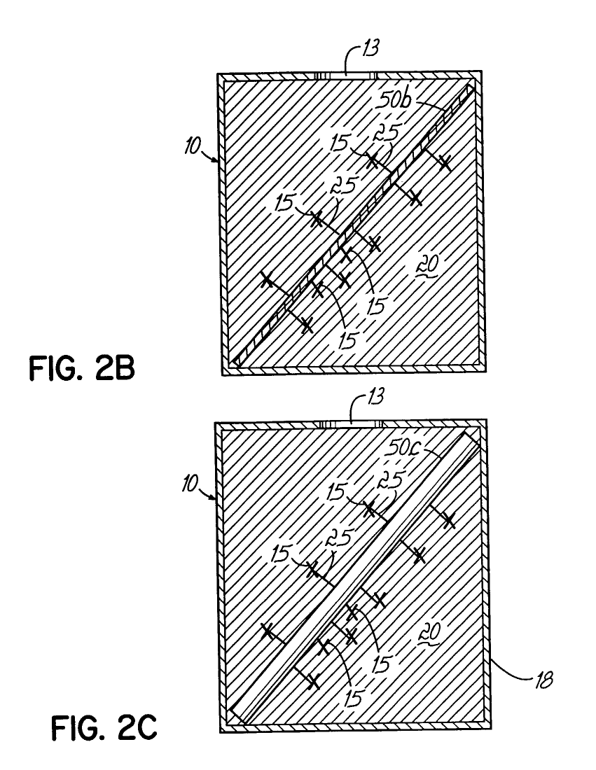

In other embodiments, and with reference to FIG. 2, the inhibitor compound 15 is additionally contained on an exterior surface of a support structure 50. The support structure 50 may be solid or may have one or more internal voids, such as pores or channels. In this embodiment, the inhibitor compound 15 may be contained on both exterior and interior surfaces of the support structure 50, and the foodstuff 20 may contact both exterior and interior surfaces of the support 50. The inhibitor compound 15 may be irreversibly adapted directly to the support 50, or may be irreversibly adapted indirectly to the support 50, such as via a linker 25. The support structure 50 may be freely contained in the container 10, or may be adapted or tethered to an interior surface of the container 10 by a linker 45. The design, configuration, length, and composition of the linker 45 may be altered to allow for a desired degree of mobility with the container 10. For example, if the foodstuff 20 is a liquid, less mobility may be required for sufficient contact with the inhibitor compound 15 than if the foodstuff 20 is a semi-solid. The support structure 50 is a chemically inert material, e.g., a resin.

Examples of the embodiment described in FIG. 2 are illustrated in FIGS. 2A-C. The support structure 50 may be any configuration, such as one or more solid and/or porous and/or permeable spheres 50a (FIG. 2A), sheets 50b (FIG. 2B), and/or rods 50c (FIG. 2C). The inhibitor compound 15 may be provided to an interior and/or an exterior of the support 50 to contact the foodstuff 20 when present within container 10.

As shown in FIG. 2A, the inhibitor compound 15 may be provided by being attached to an outer surface of a sphere 50a, either directly or via linkers 25, or the inhibitor compound 15 may be provided to all the surfaces of a porous or hollow and porous sphere. For example, the inhibitor compound 15 may be inside a sphere 30 that allows a foodstuff 20 to diffuse into and out of the sphere 30 to contact the inhibitor compound 15. The sphere 50a may be adapted to the inner wall 12 of the container 10, or may be free within the container 10. In one aspect of this embodiment, a foodstuff 20 is contained within the container 10, and the sphere 50a containing the inhibitor 15 is sized to be large enough so that support structure 50a does not exit the container 10 upon removal of the foodstuff 20, but the sphere 50a is small enough so that it does not substantially preclude removal of the foodstuff 20 from the container 10. In this aspect, the support structure 50 may be also be irreversibly adapted to an extender linker 45, which is adapted to an interior surface of the container 10 to aid in the prevention of removal of the support structure 50 upon removal of the foodstuff 20.

In use, the inhibitor compound 15 contacts the foodstuff 20 under conditions sufficient to inhibit a non-enzymatic browning reaction. For example, and in one embodiment, the inhibitor compound 15 and support structure 50 is positioned within an interior surface 12 at or near an opening 13 of container 10, so that removal of the foodstuff 20 from the container 10 through the opening 13 results in contact with the inhibitor compound 12. In another embodiment, the support structure 15 is positioned at an interior surface of opening 13 such that pouring a liquid foodstuff 20 from container 10 results in contact of the liquid foodstuff 20 with inhibitor compound 12, but the support structure 50 remains in the container 10. In this embodiment, the support structure 50 may be configured as a sphere or other shape that is too large to exit the opening 13 of the container 10, but not too large so that it occludes the opening to prevent or hamper removal of the liquid foodstuff 20 from the container 10.

One or more inhibitors compounds 15 on one or more support structures 50, and with or without a linker 25, may be in a container 10. The unit 60 of an inhibitor compound 15, optional linker 25, and support 50 is configured within the container 10 so that the foodstuff 20 is, or is capable of being, in contact with the inhibitor 15 for at least a time sufficient to inhibit non-enzymatic browning. Considerations for the number and type of units 60 to be configured in the container 10 include the nature and amount of the foodstuff 20 to be contained; the type, size, composition, and configuration of container 10; the physical form of the foodstuff 20 (e.g., solid, liquid, semi-solid, gel, etc.; if a liquid, the viscosity of the liquid; etc.) in contact with the inhibitor compound 15, etc. The units 60 may be spaced within the container 10 to achieve a desired density (e.g., a defined number of units 60, or a desired concentration or amount of inhibitor compound 15 per cubic centimeter of the container 10 and/or support 50). For an inhibitor compound 15 on or in a support structure 50, more than one inhibitor compound 15 per support structure 50 may be used.

In additional embodiments, the inhibitor compound 15 is on or in a sheet 50b or a rod 50c, as shown in FIGS. 2B and 2C, respectively. The sheet 50b or rod 50c may be of any material that is inert and non-reactive with the foodstuff 20 to be contained, and may be solid or may contain one or more voids. The dimensions of the sheet 50b and/or rod 50c may vary according to the inner dimensions of the container 10, the foodstuff 20 to be contained, etc.

Thus, the inhibitor compound 15 may be contained on or within one or more support structures 50, which may be configured as one or more sheets, rods, beads, spheres, microbeads, microspheres, or particles. The inhibitor compound 15, which may be contained on a support structure 50, may further include a linker 25 to provide increased access of the inhibitor compound 15 to the foodstuff 20. If the unit 60 of inhibitor compound 15/optional linker 25/support structure 50 combination is contained within a subcontainer 35, the subcontainer may be freely movable within the container 10, or adapted to a surface 12 of the container 10 by a linker 45.

The invention will be further appreciated with reference to the following examples, which are illustrative but not limiting.

### EXAMPLE 1

Synthesis of Support Containing Inhibitor of Non-Enzymatic Browning

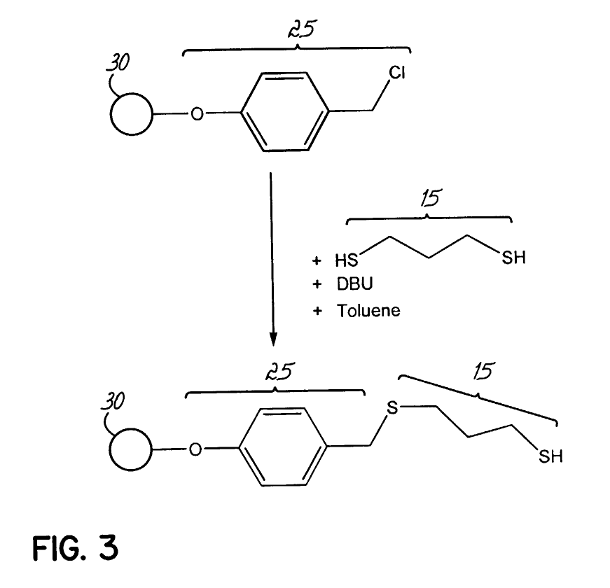

The procedure to synthesis a support structure 30 containing 1,3-propane dithiol as an inhibitor compound 15 was a combination and modification of procedures described by Rademann and Schmid, Tetrahedron Letters 1996, 37:3989 and DiCesare et al., Synthesis, 1980, 953, each of which is expressly incorporated by reference herein in its entirety. The synthesis is shown schematically in FIG. 3.

To a container containing 2.0 g of styrene beads, 120-230 microns, as the support structure 30 (Resin PEG-gratted polystyrene, Argonaut Technologies, Foster City, Calif.), was initially swelled in toluene and the following were added: 15 ml toluene, 1.02 g 1,3-propane dithiol, and 0.29 g 1,5-diazabicyclo [5.4.0] under-5-enc (DBU) (all from Aldrich, St. Louis Mo.). The solution was stirred at ambient temperature for seventeen hours. The yellowish suspension was filtered and washed three times with toluene. The beads were then washed with MTBE, hexane, ethanol and finally with isopropanol, resulting in a recovery of 1.87 g of the support structure 30/linker 25/inhibitor compound 15 combination, specifically, 1,3-propane dithiol bound to a styrene bead via a linker. The concentration of 1,3-propane dithiol on the beads was 0.2 mmol/g.

### EXAMPLE 2

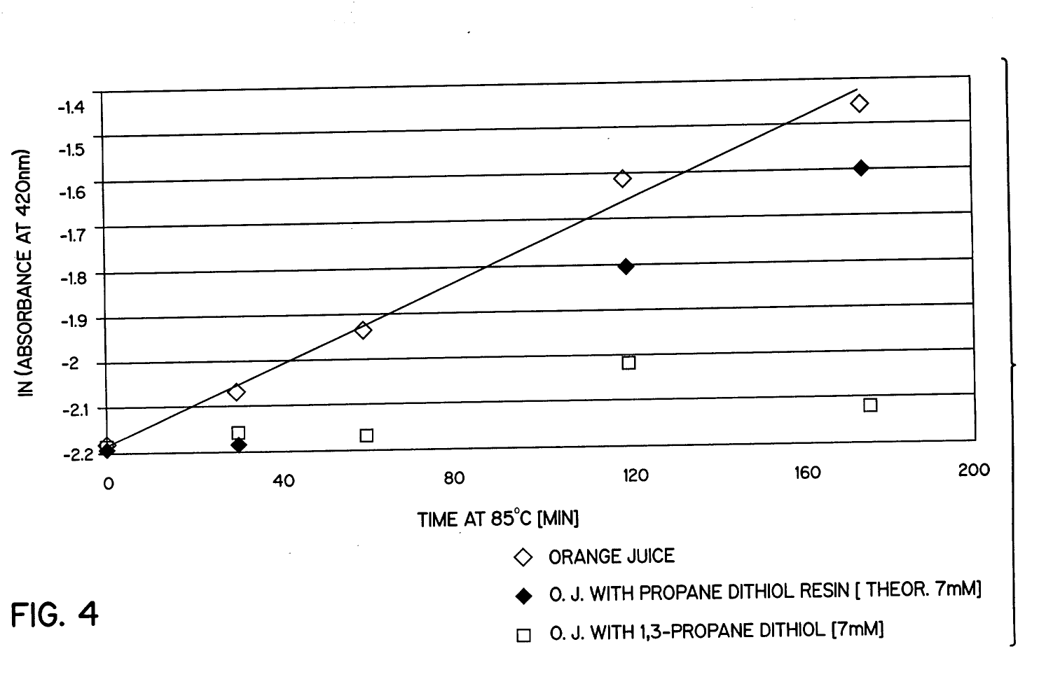

Inhibition of Non-Enzymatic Browning in Orange Juice FIG. 4 is a graph illustrating the efficacy of the inventive device and method on inhibiting non-enzymatic browning in a foodstuff. Three glass containers were filled with commercially available orange juice. One of the containers, used as the control (open diamonds), did not contain an inhibitor compound. Resin-free 1,3-propane dithiol, an inhibitor compound, was placed in a second container (open squares) at a concentration of 7 mM. The third container had the propane dithiol bound resin, prepared as described in Example 1, at a theoretical concentration of 7 mM estimated upon 100% yield in loading the bead.

The containers of liquid orange juice, either without 1,3-propane dithiol (control), with free 1,3-propane dithiol, or with resin bound 1,3-propane dithiol, were heated to 85° C. to accelerate the browning process. The extent of browning of the juice in each container was compared by spectrophotometric measurement at 420 nm of juice samples, three ml, taken from each container at various time intervals up to three hours. The samples were cooled to ambient temperature and then centrifuged. The supernatant was recovered and mixed with two ml of methanol and centrifuged. The supernatant was then filtered through a 0.45 micron membrane before spectrophotometric analysis. The results are shown in FIG. 4.

For purposes of analysis, the absorbance in the control container (open diamonds) after 175 minutes was considered as 100% browning. After 30 minutes, the control juice showed 20% browning, while the juice in the containers with free inhibitor (open squares) and resin-bound inhibitor (closed diamonds) showed no browning. After 120 minutes, the control juice showed 80% browning, the juice in the container with resin-bound inhibitor showed 53% browning, and the juice in the container with free inhibitor showed 10% browning. These results indicated that the resin-bound inhibitor worked well, and that the resin-free inhibitor had the greatest effect on inhibiting non-enzymatic browning of the orange juice.

### EXAMPLE 3

Reagent Inhibition of Non-Enzymatic Browning in Orange Juice

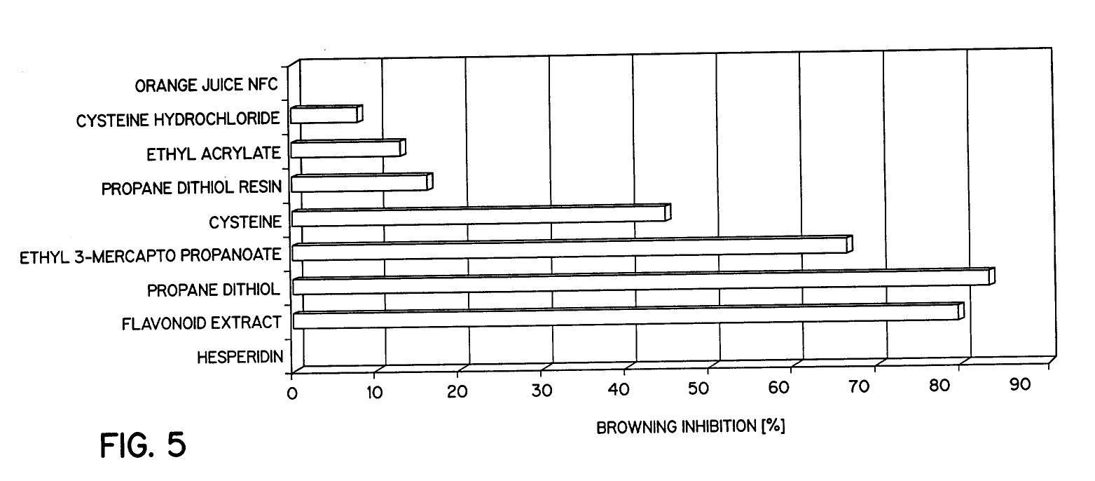

Various reagents were evaluated for their ability to inhibit non-enzymatic browning of orange juice at 85° C. The results are shown in FIG. 5. Among these reagents, cysteine, ethyl ε-mercapto propanoate, propane dithiol, and a flavonoid extract exhibited the greatest percent inhibition. The flavonoid extract was an ethanol extract from oranges. Hesperidin, bioflavovoind found in many fruits, did not inhibit the non-enzymatic browning reaction.

It should be understood that the embodiments of the present invention shown and described in the specification are only preferred embodiments of the inventor who is skilled in the art and are not limiting in any way. Therefore, various changes, modifications or alterations to these embodiments may be made or resorted to without departing from the spirit of the invention and the scope of the following claims.

What is claimed is:

1. A foodstuff container having an interior surface, said container comprising a non-enzymatic browning inhibitor compound affixed to said interior surface for contact with a contained foodstuff sufficient to inhibit non-enzymatic browning of said foodstuff.

2. The container of claim 1 wherein said inhibitor compound is within a matrix of said interior surface.

3. The container of claim 1 wherein said inhibitor compound is on said interior surface.

4. The container of claim 1 wherein said inhibitor compound is affixed to said interior surface via a linker.

5. The container of claim 1 wherein said inhibitor compound is contained within a support structure.

6. The container of claim 1 wherein the concentration of said inhibitor compound is up to about 1.7 mmol/g.

7. A foodstuff container having an interior surface, said container comprising
a non-enzymatic browning inhibitor compound, and
a support structure for supporting said inhibitor compound within said container to contact a contained foodstuff sufficient to inhibit non-enzymatic browning of said foodstuff.

8. The container of claim 7 further comprising a linker between said interior surface of said container and said support structure.

9. The container of claim 7 wherein said support structure is carried for movement within said container.

10. The container of claim 7 wherein said support structure is inert.

11. The container of claim 7 wherein said support structure is hydrophilic.

12. The container of claim 7 wherein said support structure is selected from the group consisting of a sphere, a sheet, a cylinder, a rod, a bead, a microbead, a sac, a vesicle, and combinations thereof.

13. The container of claim 7 wherein said support structure is affixed to said interior surface.

14. The container of claim 7 wherein said support structure is free in said container.

15. The container of claim 7 wherein said inhibitor is irreversibly affixed to said support structure.

16. The container of claim 7 wherein said inhibitor is selected from the group consisting of 1,3-propane dithiol, cysteine hydrochloride, ethyl acrylate, cysteine, ethyl 3-mercapto propanoate, flavonoid, and combinations thereof.

17. The container of claim 16 wherein the concentration of said inhibitor is up to about 1.7 mmol/g.

18. The container of claim 16 wherein said inhibitor is 1,3-propane dithiol and the concentration of said 1,3-propane dithiol is up to about 0.45 mmol/g.

19. The container of claim 7 wherein the foodstuff is a citrus product.

20. A support structure adapted for placement in a foodstuff container, said support structure providing an inhibitor compound to inhibit non-enzymatic browning of said contained foodstuff, said inhibitor compound irreversibly adapted to said support structure via a linker for contact with said foodstuff.

21. The support structure of claim 20 further contained in a subcontainer.

22. The support structure of claim 20 sized to be retained within said container upon removal of said foodstuff.

23. The support structure of claim 20 contained with said foodstuff container.

24. A method for inhibiting browning of a foodstuff comprising providing a foodstuff contained in a container, said container further comprising a non-enzymatic browning inhibitor compound, and contacting said foodstuff with said inhibitor compound under conditions sufficient to inhibit non-enzymatic browning of said foodstuff.

25. The method of claim 24 wherein said inhibitor compound contacts said foodstuff intermittently.

26. The method of claim 24 wherein said inhibitor compound contacts said foodstuff upon removal from said container.

27. The method of claim 24 wherein said contained foodstuff is a juice.

28. The method of claim 24 wherein said foodstuff contacts said inhibitor compound during agitation of said container.
